(19) United States
(12) Patent Application Publication
(10) Pub. No.: US 2007/0133014 A1
(43) Pub. Date: Jun. 14, 2007

(54) Mobile printer having an electronic book function and printing method thereof

(75) Inventor: Yu-bin Lee, Seongnam-si (KR)

Correspondence Address: STANZIONE & KIM, LLP, 919 18TH STREET, N.W., SUITE 440, WASHINGTON, DC, 20006, US

(73) Assignee: SAMSUNG Electronics Co., Ltd., Suwon-si (KR)

(21) Appl. No.: 11/491,923

(22) Filed: Jul. 25, 2006

(30) Foreign Application Priority Data
Dec. 8, 2005 (KR) 2005-119368

(51) Int. Cl. G06F 3/12

(52) U.S. Cl. 358/1.1

(57) ABSTRACT

A mobile printer having an electronic (e)—book function and a printing method thereof. The mobile printer includes a liquid crystal display (LCD) to display an electronic (e)—book, a printing part to print a text corresponding to a printing range selected of the electronic (e)—book displayed on the LCD, and a controlling part to control the printing part to display the electronic (e)—book on the LCD and to print the text corresponding to the selected printing range. Accordingly, it is possible to view and print the electronic (e)—book anywhere and anytime, so that a user's convenience increases.

### CROSS-REFERENCE TO RELATED APPLICATIONS

This application claims benefit under 35 U.S.C. § 119(a) of Korean Patent Application No.2005-119368, filed Dec. 8, 2005, in the Korean Intellectual Property Office, the entire contents of which are incorporated herein by reference.

### BACKGROUND OF THE INVENTION

1. Field of the Invention

The present general inventive concept relates to a mobile printer. More particularly, the present general inventive concept relates to a mobile printer and a printing method thereof, which have an electronic (e)—book function to display a document or an image for a user to view the electronic (e)—book by, and to instantly print his or her desired document or image.

2. Description of the Related Art

Generally, an electronic (e)—book function is provided through an electronic display, for example, a liquid crystal display (LCD) processed in a digital form, different from an existing method of manufacturing a book by use of paper. More particularly, a general electronic (e)—book function includes a method of displaying a document stored in a personal computer to a monitor, and a recently developed method of displaying the electronic (e)—book through portable devices such as a mobile communication terminal, a personal digital assistant (PDA) and a portable multimedia player (PMP), when a user moves.

The electronic (e)—book function provides various multi-media functions that have not been implemented in the paper book, and, thus increases the user's convenience. However, the electronic (e)—book has an inconvenience when the user prints a worth-while part or an important part on the paper for keeping. In particular, the user is further inconvenienced when the user is moving or when there is no printing device available around him or her.

A mobile printer is one example of a small-sized portable printing device. More particularly, the mobile printer has an infrared function that enables the mobile printer to wirelessly receive the document from a laptop, the mobile communication terminal, the PDA and the PMP for printing.

However, the mobile printer needs a document-transmitting portable device to print the received document. Accordingly, the portable device and the mobile printer are required to print the document stored in the portable device.

### SUMMARY OF THE INVENTION

An aspect of the present general inventive concept provides a mobile printer having an electronic (e)—book function and a printing method thereof, which is capable of displaying and printing a document while moving, by having an electronic (e)—book function in a portable mobile printer.

Additional aspects and utilities of the present general inventive concept will be set forth in part in the description which follows and, in part, will be obvious from the description, or may be learned by practice of the general inventive concept.

The foregoing and/or other aspects and utilities of the present general inventive concept may be achieved by providing a mobile printer having an electronic (e)—book function, including a liquid crystal display (LCD) to display an electronic (e)—book, a printing part to print a text corresponding to a printing range selected of the electronic (e)—book displayed on the LCD, and a controlling part to control the printing part to display the electronic (e)—book on the LCD and print the text corresponding to the selected printing range.

The mobile printer having the electronic (e)—book function may include an operating part having a setting key to set and to change at least one of a size, a font and a color of the text, a scroll or direction key to select the printing range, and a printing command key to print the text corresponding to the printing range.

The controlling part may process the text according to at least one setting value of a size, a font and a color of the text, and displays the processed text on the LCD.

The printing part may print the text in one of a dye diffusion thermal transfer (D2T2) method and a thermal wax method.

The mobile printer having the electronic (e)—book function may include an interfacing part to interface with an external.

The foregoing and/or other aspects and utilities of the present general inventive concept may also be achieved by providing a method of printing for a mobile printer having an electronic (e)—book function, including displaying an electronic (e)—book, and printing a text corresponding to a printing range selected of the electronic (e)—book displayed.

The operation of displaying processes the text according to at least one setting value of a size, a font and a color of the text.

The operation of printing prints the text in one of a dye diffusion thermal transfer (D2T2) method and a thermal wax method.

The foregoing and/or other aspects and utilities of the present general inventive concept may also be achieved by providing a mobile printer, including a display unit provided on a side of the mobile printer to display an image, a printing part to print the displayed image on a recording medium provided therein, and a control unit to control the printing part and the display unit.

The foregoing and/or other aspects and utilities of the present general inventive concept may also be achieved by providing a mobile display unit, including a control part to select a portion of an image displayed thereon, and a printing part to print the selected portion on a recording medium.

The foregoing and/or other aspects and utilities of the present general inventive concept may also be achieved by providing a method of printing with a mobile printer, the method including selecting a portion of a displayed image, and printing the selected portion of the displayed image.

### BRIEF DESCRIPTION OF THE DRAWINGS

These and/or other aspects and advantages of the present general inventive concept will become apparent and more readily appreciated from the following description of the embodiments, taken in conjunction with the accompanying drawings of which:

FIG. 1 illustrates a mobile printer according to an embodiment of the present general inventive concept;

FIG. 2 is a block diagram illustrating an exemplary embodiment of the mobile printer of FIG. 1, according to an embodiment of the present general inventive concept; and

FIG. 3 is a flowchart illustrating a method of printing for a mobile printer having an electronic (e)—book function according an embodiment of the present general inventive concept.

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept by referring to the figures.

FIG. 1 illustrates a mobile printer according to an embodiment of the present general inventive concept.

Referring to FIG. 1, a mobile printer 100 is portable, and has an electronic (e)—book function to display an electronic (e)—book stored in an internal storing part or an external memory. The mobile printer 100 is one example of a printing device to print on a printing paper a part of the displayed electronic (e)—book selected by a user. The mobile printer 100 has a case 170 to house the mobile printer 100.

The mobile printer 100 has a liquid crystal display (LCD) 130 on an upper surface of the case 170, and a paper outlet 185 on another surface of the case 170 that does not have the LCD 130.

The mobile printer 100 displays the electronic (e)—book in a text file on the LCD 130 located on the upper surface of the case 170. The mobile printer 100 immediately prints on the printing paper a part or an entire part selected of a displayed text, and then ejects the printed paper out of the paper outlet 185.

The LCD 130 provided in the mobile printer 100 occupies a predetermined area of the case 170 of the mobile printer 100. That is, a size of the LCD 130 is smaller than or equal to a size of the case 170. For example, as illustrated in FIG. 1, when the LCD 130 is located on the upper surface of the mobile printer 100, the LCD 130 occupies an area of the upper surface of the case 170 excluding an area occupied by keys of a key type operating part 140. When the key type operating part 140 is incorporated into the LCD 130, for example, as a touch screen, or placed on the other surface of the case 170, the size of the LCD 130 may be enlarged to a size equivalent to the size of the case 170. The size of the mobile printer 100 is similar to the size of the printing paper, so the size of the LCD 130 may be provided equivalent to the size of the printing paper.

The above mentioned mobile printer 100 is an exemplary embodiment where the LCD 130 is located on the upper surface of the case 170. However, in other embodiments, the LCD 130 may be located on any one of four surfaces on the sides of the case 170, excluding a lower surface of the case 170. The paper outlet 185 may then be located on one of four surfaces on the sides that does not have the LCD 130.

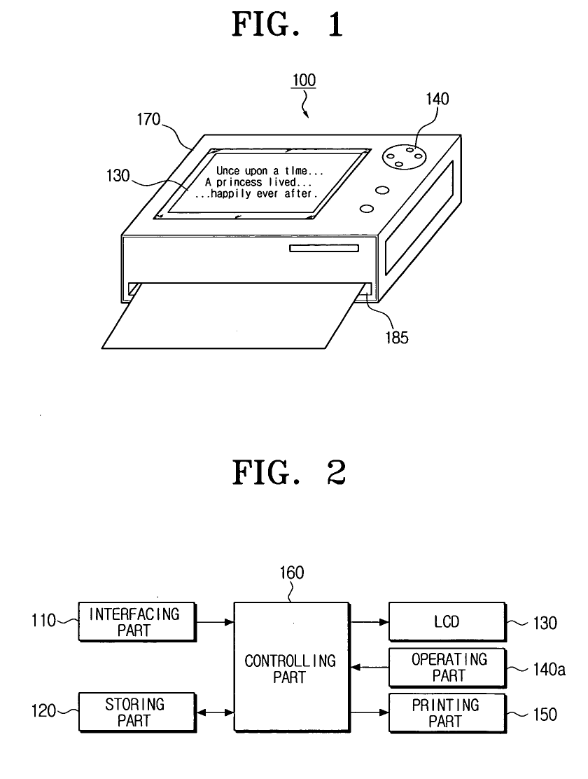

FIG. 2 is a block diagram illustrating an exemplary embodiment of the mobile printer of FIG. 1 according to an embodiment of the present general inventive concept.

Referring to FIG. 2, the mobile printer 100 includes an interfacing part 110, a storing part 120, the LCD 130, an operating part 140a, a printing part 150 and a controlling part 160.

The interfacing part 110 provides an interface with an external memory. More particularly, the interfacing part 110 provides the interface to receive the electronic (e)—book stored in the external memory in a text file. The external memory may be any conventional memory device including a universal serial bus (USB), a memory card, and a memory stick.

Various electronic (e)—books may be stored in the storing part 120 in the text file. The storing part 120 may be a flash memory and a hard disk drive (HDD).

The LCD 130 may be located in the upper surface of the mobile printer 100 or at any one of the four surfaces on the sides thereof. The LCD 130 displays the electronic (e)—book from a text file received through the interfacing part 110, or the electronic (e)—book stored in the storing part 120.

The operating part 140a is an exemplary embodiment of the key-type operating part 140 illustrated in FIG. 1, and allows the user to input commands to the mobile printer 100. The operating part 140a may be provided with various function keys to input a user command. In addition, the operating part 140a may be provided with a setting key to set and to change a size, a font and a color of a text to be displayed on the LCD 130. Also, a scroll key or a direction key may be provided to select a printing range of the displayed text.

The LCD 130 may have a touch screen function to select the printing range. In another embodiment of the present general inventive concept, the touch screen function of the LCD 130 may include the operating part 140a so that the user's commands can be input through the touch screen. That is, the user can change a size, a font and a color of a text to be displayed on the LCD 130 through the LCD 130 itself.

The printing part 150 prints the text selected by the user through the operating part 140a on the printing paper. The selected text corresponds to the displayed text on the LCD 130 in the selected printing range. A printing method may be one of a dye diffusion thermal transfer (D2T2) method and a thermal wax method.

The controlling part 160 processes the text to be displayed according to a size, a font, and a color of the text set through the operating part 140a. The controlling part 160 displays the processed text on the LCD 130. The controlling part 160 controls the printing part 150 to print the text corresponding to the selected printing range, when the printing range is selected through the operating part 140a and a printing command is input.

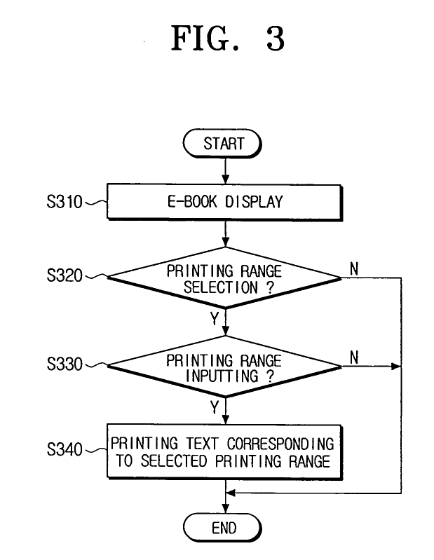

FIG. 3 is a flowchart illustrating a method of printing for the mobile printer having the electronic (e)—book function according an embodiment of the present general inventive concept.

Referring to FIG. 3, the controlling part 160 displays the electronic (e)—book on the LCD 130 (Operation S310). The controlling part 160 detects a connection with an external memory through the interfacing part 110. The controlling part 160 processes the electronic (e)—book in the text file stored in one of the external memory or the storing part 120, according to a setting value set by a user and displays the electronic (e)—book.

The controlling part 160 determines whether the printing range of the text displayed on the LCD 130 is selected or not (Operation S320). The printing range may be a range of one page displayed, a range of consecutive several pages or the entire electronic (e)—book. It is possible to set and change a printing setting value in printing.

When the controlling part 160 determines that the printing range is selected, the controlling part 160 determines whether a printing command is input or not (S330).

When the controlling part 160 determines that the printing command is input, the controlling part 160 controls the printing part 150 to print the text corresponding to the selected printing range (Operation S340).

As abovementioned, according to an embodiment of the present general inventive concept, it is possible to view and print an electronic (e)—book anywhere and anytime, and, thus is very convenient for a user.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. A mobile printer having an electronic (e)—book function, comprising:
a liquid crystal display (LCD) to display an electronic (e)—book;
a printing part to print a text corresponding to a printing range selected of the electronic (e)—book displayed on the LCD; and
a controlling part to control the printing part to display the electronic (e)—book on the LCD and to print the text corresponding to the selected printing range.

2. The mobile printer of claim 1, further comprising:
an operating part comprising:
a setting key to set and to change at least one of a size, a font and a color of the text,
a scroll or direction key to select the printing range, and
a printing command key to print the text corresponding to the printing range.

3. The mobile printer of claim 1, wherein the controlling part processes the text according to at least one setting value of a size, a font and a color of the text, and displays the processed text on the LCD.

4. The mobile printer of claim 1, wherein the printing part prints the text in one of a dye diffusion thermal transfer (D2T2) method and a thermal wax method.

5. The mobile printer of claim 1, further comprising:
an interfacing part to interface with an external memory.

6. A method of printing with a mobile printer having an electronic (e)—book function, comprising:
displaying an electronic (e)—book; and
printing a text corresponding to a printing range selected of the electronic (e)—book displayed.

7. The printing method of claim 6, wherein the displaying of the electronic (e)—book comprises processing the text according to at least one setting value of a size, a font and a color of the text.

8. The printing method of claim 6, wherein the printing of the text is one of a dye diffusion thermal transfer (D2T2) method and a thermal wax method.

9. A mobile printer, comprising:
a display unit provided on a side of the mobile printer to display an image;
a printing part to print the displayed image on a recording medium provided therein; and
a control unit to control the printing part and the display unit.

10. The mobile printer of claim 9, wherein the display unit is approximately the same size as the recording medium of the printing part.

11. The mobile printer of claim 9, wherein the display unit comprises a touch screen function to select a portion of the image to be printed.

12. The mobile printer of claim 11, wherein the touch screen unit can select at least one of a size, a font, and a color of the image to be printed.

13. The mobile printer of claim 11, wherein the control unit controls the display unit to display selected portions of an image and the printing part to print the selected portion of the image.

14. The mobile printer of claim 13, wherein the image is a text file to be displayed as an electronic (e)—book and the selected portion of the image comprises a range of the text to be printed.

15. The mobile printer of claim 9, wherein the control part comprises:
an operating part to select a portion of the image to be printed.

16. The mobile printer of claim 9, further comprising:
a storing part to store the image.

17. A mobile display unit, comprising:
a control part to select a portion of an image displayed thereon; and
a printing part to print the selected portion on a recording medium.

18. The mobile display unit of claim 17, wherein the control part comprises a touch screen function on the display unit.

19. A method of printing with a mobile printer, the method comprising:
selecting a portion of a displayed image; and
printing the selected portion of the displayed image.

20. The method of claim 19, wherein the printing of the selected portion of the displayed image includes determining whether a printing command has been selected and printing the image when it is determined that a printing command has been selected.
